(19) United States
(12) Patent Application Publication
(10) Pub. No.: US 2025/0038853 A1
(43) Pub. Date: Jan. 30, 2025

(54) SPLIT CYCLIC PREFIX BEAM GAIN MEASUREMENT

(71) Applicant: QUALCOMM Incorporated, San Diego, CA (US)

(72) Inventors: Alexander SVERDLOV, Rehovot (IL); Igor GUTMAN, Hod HaSharon (IL)

(21) Appl. No.: 18/716,652

(22) PCT Filed: Jan. 4, 2023
(86) PCT No.: PCT/US2023/060110

§ 371 Date: Jun. 5, 2024

(30) Foreign Application Priority Data
Feb. 4, 2022 (IL) 290353

(51) Int. Cl. H04B 10/294; H04B 17/309

(52) U.S. Cl. CPC H04B 10/2942; H04B 17/346

(57) ABSTRACT

Methods, systems, and devices for wireless communications are described. For instance, a wireless device may measure a first portion of a cyclic prefix (CP) of a wireless transmission received using a first subset of a set of analog receive elements. The wireless device may measure a second portion of the CP of the wireless transmission using a second subset of the set of analog receive elements. The wireless device may determine a beam gain for the set of analog receive elements based on measuring the first portion of the CP received using the first subset and the second portion of the CP received using the second subset. In some examples, measuring using the first subset and the second subset may be associated with improved automatic gain control performance and/or transmission power control as compared to measuring with each of a set of analog receive elements.

### CROSS REFERENCES

The present application is a 371 national stage filing of International PCT Application No. PCT/US2023/060110 by SVERDLOV et al., entitled “SPLIT CYCLIC PREFIX BEAM GAIN MEASUREMENT,” filed Jan. 4, 2023; and claims priority to Israel Patent Application No. 290353 by SVERDLOV et al., entitled “SPLIT CYCLIC PREFIX BEAM GAIN MEASUREMENT,” filed Feb. 4, 2022, each of which is assigned to the assignee hereof, and each of which is expressly incorporated by reference in its entirety herein.

### FIELD OF TECHNOLOGY

The following relates to wireless communications, including split cyclic prefix beam gain measurement.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support split cyclic prefix beam gain measurement. Generally, the described techniques provide for a wireless device to account for a processing gain that is contributed by one or more components of the communication pathway of the wireless device when performing automatic gain control. For instance, the wireless device may measure a first portion of a cyclic prefix of a wireless transmission received using a first subset of a set of analog receive elements, where the first subset excludes at least one analog receive element of the set. The wireless device may measure a second portion of the cyclic prefix of the wireless transmission received using a second subset of the set of analog receive elements, where the second subset includes the at least one analog receive element of the set and one or more analog receive elements of the first subset. The wireless device may determine a beam gain for the set of analog receive elements based at least in part on measuring the first portion of the cyclic prefix received using the first subset and the second portion of the cyclic prefix received using the second subset of the set of analog receive elements. The wireless device may perform an automatic gain control operation for the set of analog receive elements based at least in part on determining the beam gain.

A method for wireless communication at a wireless device is described. The method may include measuring a first portion of a cyclic prefix of a wireless transmission received using a first subset of a set of analog receive elements, where the first subset excludes at least one analog receive element of the set, measuring a second portion of the cyclic prefix of the wireless transmission received using a second subset of the set of analog receive elements, where the second subset includes the at least one analog receive element of the set and one or more analog receive elements of the first subset, determining a beam gain for the set of analog receive elements based on measuring the first portion of the cyclic prefix received using the first subset and the second portion of the cyclic prefix received using the second subset of the set of analog receive elements, and performing an automatic gain control operation for the set of analog receive elements based on determining the beam gain.

An apparatus for wireless communication at a wireless device is described. The apparatus may include a processor, memory coupled with the processor, and instructions stored in the memory. The instructions may be executable by the processor to cause the apparatus to measure a first portion of a cyclic prefix of a wireless transmission received using a first subset of a set of analog receive elements, where the first subset excludes at least one analog receive element of the set, measure a second portion of the cyclic prefix of the wireless transmission received using a second subset of the set of analog receive elements, where the second subset includes the at least one analog receive element of the set and one or more analog receive elements of the first subset, determine a beam gain for the set of analog receive elements based on measuring the first portion of the cyclic prefix received using the first subset and the second portion of the cyclic prefix received using the second subset of the set of analog receive elements, and perform an automatic gain control operation for the set of analog receive elements based on determining the beam gain.

Another apparatus for wireless communication at a wireless device is described. The apparatus may include means for measuring a first portion of a cyclic prefix of a wireless transmission received using a first subset of a set of analog receive elements, where the first subset excludes at least one analog receive element of the set, means for measuring a second portion of the cyclic prefix of the wireless transmission received using a second subset of the set of analog receive elements, where the second subset includes the at least one analog receive element of the set and one or more analog receive elements of the first subset, means for determining a beam gain for the set of analog receive elements based on measuring the first portion of the cyclic prefix received using the first subset and the second portion of the cyclic prefix received using the second subset of the set of analog receive elements, and means for performing an automatic gain control operation for the set of analog receive elements based on determining the beam gain.

A non-transitory computer-readable medium storing code for wireless communication at a wireless device is described. The code may include instructions executable by a processor to measure a first portion of a cyclic prefix of a wireless transmission received using a first subset of a set of analog receive elements, where the first subset excludes at least one analog receive element of the set, measure a second portion of the cyclic prefix of the wireless transmission received using a second subset of the set of analog receive elements, where the second subset includes the at least one analog receive element of the set and one or more analog receive elements of the first subset, determine a beam gain for the set of analog receive elements based on measuring the first portion of the cyclic prefix received using the first subset and the second portion of the cyclic prefix received using the second subset of the set of analog receive elements, and perform an automatic gain control operation for the set of analog receive elements based on determining the beam gain.

Some examples of the method, apparatuses, and non-transitory computer-readable medium described herein may further include operations, features, means, or instructions for determining that a signal to noise ratio parameter may be above a threshold value and measuring the first portion of the cyclic prefix received using the first subset of the set of analog receive elements based on determining that the signal to noise ratio may be above the threshold value.

Some examples of the method, apparatuses, and non-transitory computer-readable medium described herein may further include operations, features, means, or instructions for determining a first received signal strength indicator based on measuring the first portion of the cyclic prefix and determining a second received signal strength indicator based on measuring the second portion of the cyclic prefix, where determining the beam gain for the set of analog receive elements may be based on the determined first received signal strength indicator and the second received signal strength indicator.

Some examples of the method, apparatuses, and non-transitory computer-readable medium described herein may further include operations, features, means, or instructions for comparing the first received signal strength indicator with the second received signal strength indicator, where determining the beam gain may be based on comparing the first received signal strength indicator with the second received signal strength indicator.

Some examples of the method, apparatuses, and non-transitory computer-readable medium described herein may further include operations, features, means, or instructions for measuring an additional portion of the wireless transmission distinct from the cyclic prefix, where determining the second received signal strength indicator may be based on measuring the additional portion of the wireless transmission.

Some examples of the method, apparatuses, and non-transitory computer-readable medium described herein may further include operations, features, means, or instructions for communicating a physical downlink shared channel transmission, a physical downlink control channel transmission, a synchronization signal block, a transmission reference signal, or any combination thereof based on the determined beam gain.

In some examples of the method, apparatuses, and non-transitory computer-readable medium described herein, the first subset of the set of analog receive elements includes a first subset of analog receive chains of a set of analog receive chains and the second subset of the set of analog receive elements includes a second subset of analog receive chains of the set of analog receive chains.

In some examples of the method, apparatuses, and non-transitory computer-readable medium described herein, the wireless device includes a user equipment (UE) or a base station.

### BRIEF DESCRIPTION OF THE DRAWINGS

FIG. 1 illustrates an example of a wireless communications system that supports split cyclic prefix beam gain measurement in accordance with aspects of the present disclosure.

FIG. 2 illustrates an example of a wireless communications system that supports split cyclic prefix beam gain measurement in accordance with aspects of the present disclosure.

FIG. 3 illustrates an example of a communication pathway that supports split cyclic prefix beam gain measurement in accordance with aspects of the present disclosure.

FIG. 4 illustrates an example of a process flow that supports split cyclic prefix beam gain measurement in accordance with aspects of the present disclosure.

FIGS. 5 and 6 show block diagrams of devices that support split cyclic prefix beam gain measurement in accordance with aspects of the present disclosure.

FIG. 7 shows a block diagram of a communications manager that supports split cyclic prefix beam gain measurement in accordance with aspects of the present disclosure.

FIG. 8 shows a diagram of a system including a device that supports split cyclic prefix beam gain measurement in accordance with aspects of the present disclosure.

FIGS. 9 through 11 show flowcharts illustrating methods that support split cyclic prefix beam gain measurement in accordance with aspects of the present disclosure.

### DETAILED DESCRIPTION

A wireless device, such as a user equipment (UE) or a base station, may receive a signal over multiple analog receive chains, where each analog receive chain may include a respective one or more analog receive elements (e.g., a radio frequency (RF) element, a low noise amplifier (LNA)). The signals received over the multiple analog receive chains may be combined via a radio frequency combiner (RF) and the RF combiner may pass the resulting combined signal toward a digital receiver (e.g., via an intermediate frequency (IF) component and an analog to digital converter (ADC)). In some examples, one or more of the RF combiner, the IF component, the ADC, or the digital receiver may also be referred to as analog receive elements. The digital receiver may measure a received signal strength indicator (RSSI) associated with the combined signal. The wireless device may determine a beam gain based on the measured RSSI and may perform automatic gain control (AGC), which may decrease a likelihood that the digital receiver receives a signal that is too weak (e.g., due to a beam gain that is too low) to be correctly decoded and/or that the digital receiver receives an over-saturated signal (due to a beam gain that is too high).

However, in some examples, the signal received by the digital receiver may be affected by both a processing gain (e.g., introduced by the RF combiner or another component of the pathway between the multiple analog receive chains and the digital receiver) and a beam gain. Thus, in examples in which the wireless device fails to account for the processing gain, the wireless device may determine a beam gain for AGC that is more different from the actual beam gain than a beam gain that the wireless device may determine if the processing gain were not present. As the beam gain determined by the wireless device becomes more different from the actual beam gain, the likelihood of AGC preventing the wireless device from receiving a signal that is too weak or an over-saturated signal may decrease. As such, the efficiency of wireless communications may decrease.

The present disclosure describes methods that may enable the wireless device to at least partially account for processing gain when determining a beam gain for performing AGC. For instance, the wireless device may measure a first portion of a signal (e.g., a first portion of a cyclic prefix (CP)) using a subset of a set of analog receive elements and may determine a first RSSI associated with the first portion of the signal. Similarly, the wireless device may measure a second portion of a signal (e.g., a second portion of the CP and/or a remaining portion of the signal) using a second subset of the analog receive elements (e.g., each of the analog receive elements of the set) may determine a second RSSI associated with the second portion of the signal. The first RSSI and the second RSSI may each be associated with a different processing gain, as the first portion of the signal and the second portion of the signal may be measured over a different number of analog receive elements (e.g., the subset of the set of analog receive elements may have fewer analog receive elements as compared to the set). Accordingly, the wireless device may account for the processing gain by comparing the first RSSI and the second RSSI and may determine a beam gain that is closer to the actual beam gain as compared to at least some examples in which one RSSI is determined. Accordingly, the likelihood of AGC preventing the wireless device from receiving a signal that is too weak to be correctly decoded or over-saturated may increase. As such, the efficiency of wireless communications may increase.

Aspects of the disclosure are initially described in the context of wireless communications systems. Additional aspects of the disclosure are described in the context of a communication pathway and a process flow. Aspects of the disclosure are further illustrated by and described with reference to apparatus diagrams, system diagrams, and flowcharts that relate to split cyclic prefix beam gain measurement.

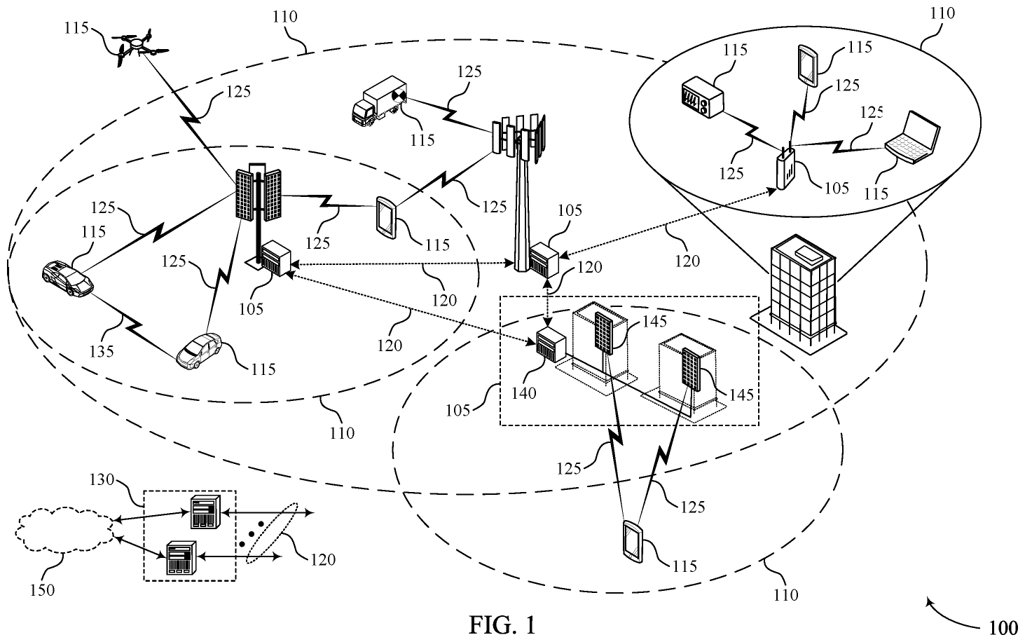

FIG. 1 illustrates an example of a wireless communications system 100 that supports split cyclic prefix beam gain measurement in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A wireless device, such as a UE 115 or a base station 105, may receive a signal over multiple analog receive chains, where each analog receive chain may include a respective one or more analog receive elements (e.g., an RF element, an LNA). The signals received over the multiple analog receive chains may be combined via a radio frequency combiner and the RF combiner may pass the resulting combined signal toward a digital receiver (e.g., via an IF component and an ADC). In some examples, one or more of the RF combiner, the IF component, the ADC, or the digital receiver may also be referred to as analog receive elements. The digital receiver may measure an RSSI associated with the combined signal. The wireless device may determine a beam gain based on the measured RSSI and may perform AGC, which may decrease a likelihood that the digital receiver receives a signal that is too weak (e.g., due to a beam gain that is too low) to be correctly decoded and/or that the digital receiver receives an over-saturated signal (due to a beam gain that is too high).

However, in some examples, the signal received by the digital receiver may be affected by both a processing gain (e.g., introduced by the RF combiner or another component of the pathway between the multiple analog receive chains and the digital receiver) and a beam gain. Thus, in examples in which the wireless device fails to account for the processing gain, the wireless device may determine a beam gain for AGC that is more different from the actual beam gain than a beam gain that the wireless device may determine if the processing gain were not present. As the beam gain determined by the wireless device becomes more different from the actual beam gain, the likelihood of AGC preventing the wireless device from receiving a signal that is too weak or an over-saturated signal may decrease. As such, the efficiency of wireless communications may decrease.

The present disclosure describes methods that may enable the wireless device to at least partially account for processing gain when determining a beam gain for performing AGC. For instance, the wireless device may measure a first portion of a signal (e.g., a first portion of a cyclic prefix (CP)) using a subset of a set of analog receive elements and may determine a first RSSI associated with the first portion of the signal. Similarly, the wireless device may measure a second portion of a signal (e.g., a second portion of the CP and/or a remaining portion of the signal) using a second subset of the analog receive elements (e.g., each of the analog receive elements of the set) may determine a second RSSI associated with the second portion of the signal. The first RSSI and the second RSSI may each be associated with a different processing gain, as the first portion of the signal and the second portion of the signal may be measured over a different number of analog receive elements (e.g., the subset of the set of analog receive elements may have fewer analog receive elements as compared to the set). Accordingly, the wireless device may account for the processing gain by comparing the first RSSI and the second RSSI and may determine a beam gain that is closer to the actual beam gain as compared to at least some examples in which one RSSI is determined. Accordingly, the likelihood of AGC preventing the wireless device from receiving a signal that is too weak to be correctly decoded or over-saturated may increase. As such, the efficiency of wireless communications may increase.

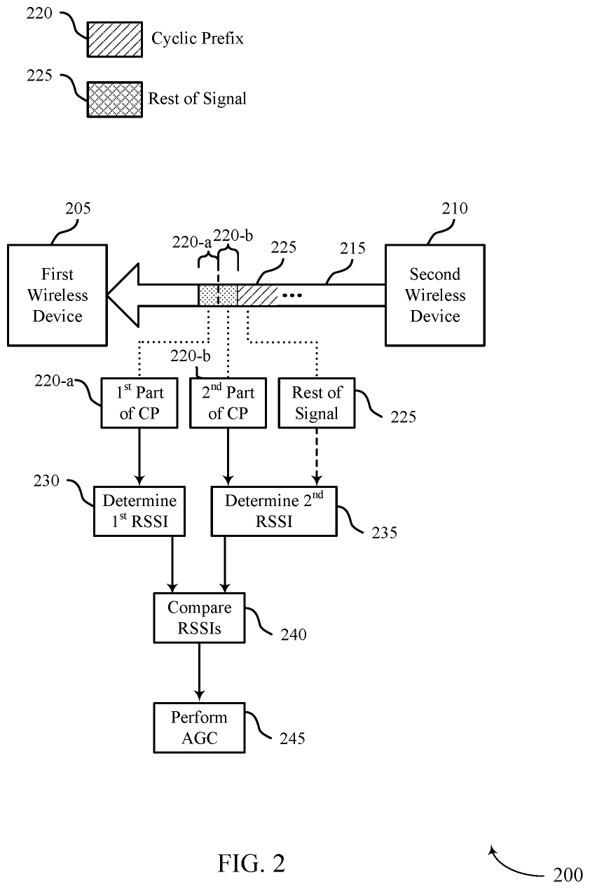

FIG. 2 illustrates an example of a wireless communications system 200 that supports split cyclic prefix beam gain measurement in accordance with aspects of the present disclosure. In some examples, wireless communications system 200 may implement one or more aspects of wireless communications system 100. For instance, first wireless device 205 and second wireless device 210 may each be an example of a UE 115 or a base station 105 as described with reference to FIG. 1.

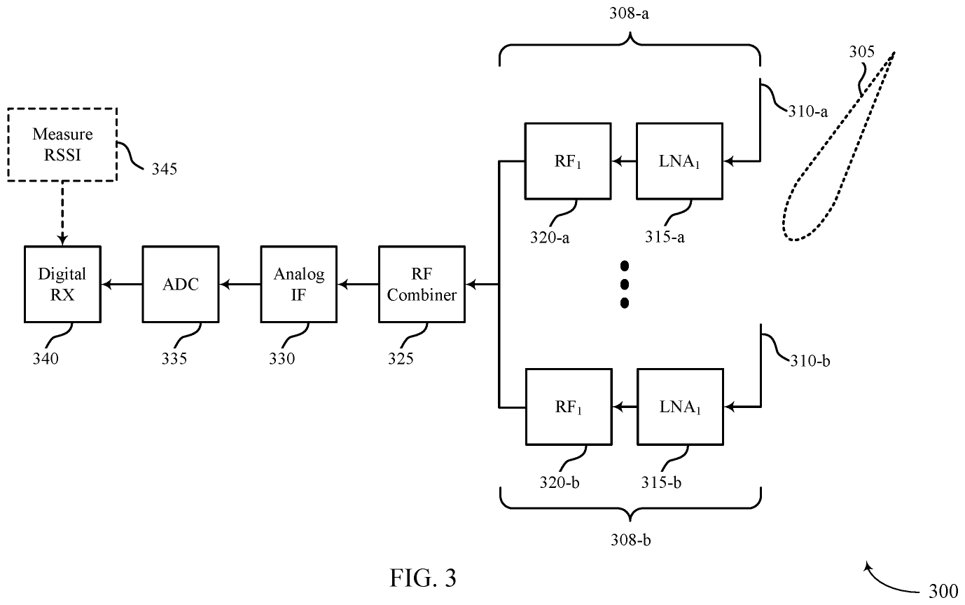

In some examples, millimeter wave (mmW) cellular systems may be employed in 5G-NR networks. In some such examples, mmW beamforming may be implemented using a hybrid approach, in which a first set of analog receive chains may receive signaling from a single digital transmitter port and in which a second set of analog receive chains may transmit signaling towards a single digital receiver port. As part of receiver processing, the digital receiver may measure RSSI for AGC outer loop control (e.g., in order to control at least one low noise amplifier (LNA)) and transmission propagation loss compensation. In some examples, although the RSSI estimates a received signal strength for a signal received at an input of an analog receive chain, the RSSI may be measured at a digital receiver. Additional details may be described herein, for instance, with reference to FIG. 3.

For mmW cellular systems, the RSSI measured at the digital receiver may be associated with a beam gain, which may be affected by a processing gain produced due to receiver beamforming (e.g., RF combining of signals received from multiple analog receive chains). For instance, in examples in which an RSSI at each RF element (e.g., each analog receive chain) is the same, the beam gain may be determined as 20*log₁₀(N)dB in a case of ideal coherent combining (e.g., the transmissions received at the RF elements may combine without destructive interference) and may equal −∞ dB in a case of ideal anti-coherent combining (e.g., the transmissions received at the RF elements may cancel each other out). In some examples, beam gain may vary and may be different for each active transmission configuration indicator (TCI) and receive beam pair. The pair may be changed per physical downlink shared channel (PDSCH), per physical downlink control channel (PDCCH), per synchronization signal block (SSB), per tracking reference signal (TRS), or any combination thereof. Accordingly, determining a single beam gain for all beam pairs may decrease the efficiency of wireless communications as compared to determining a distinct beam gain for each beam pair.

In some examples, a mismatch may be present between an assumed beam gain (e.g., BG_{assumed}) and an actual beam gain (e.g., BG_{actual}). In such examples, a transmitter's AGC may transmit with a power above a first threshold or below a second threshold, which may impact an ability of a network including the transmitter to manage a tradeoff between network distortions and may also impact link performance of a specific user. Additionally or alternatively, the receiver's AGC may have a consistent (e.g., constant) mismatch of BG_{assumed}−BG_{actual}, which may set the working point of the outer loop of the AGC such that the working point fails to satisfy a threshold. Accordingly, a tradeoff between a non-linearity (NL) of an LNA and its noise figure (NF) may be associated with values for the NL and/or the NF that fail to satisfy a respective threshold. Additionally, the delta (e.g., between BG_{assumed} and BG_{actual}) may vary per each TCI and receiver pair state. The present disclosure describes a method for measuring beam gain per each pair of receiver and transmitter beams.

The present disclosure may describe measuring a first RSSI using a subset (e.g., n out of N total analog receive elements, where N>n) of a set of analog receive elements (e.g., reception elements) and a second RSSI using each of the set of analog receive elements (e.g., each of the N total analog receive elements). For instance, the first wireless device 205 may measure the first RSSI over a first subset of a total set of analog receive chains and may measure the second RSSI over each analog receive chain of the total set of analog receive chains. For instance, second wireless device 210 may transmit a signal over channel 215 to first wireless device 205. The signal, for instance, may include a cyclic prefix (CP) 220 and a remaining portion 225 of the signal (e.g., data). In some examples, first wireless device 205 may measure a first portion 220-a of the CP 220 and a second portion 220-b of the CP 220. At 230, the first wireless device 205 may determine a first RSSI based on measuring the first portion 220-a of the CP 220. Similarly, at 235, first wireless device 205 may determine a second RSSI based on measuring the second portion 220-b of the CP 220. In some examples, first wireless device 205 may also determine the second based on measuring the remaining portion 225 of the signal. At 240, first wireless device 205 may compare the first RSSI and the second RSI and may proceed to 245. At 245, the first wireless device 205 may perform AGC based on comparing the RSSIs (e.g., based on a beam gain determined by comparing the RSSIs).

When measuring the first portion 220-a of the CP 220 on a single analog receive element, the processing gain contributed by an RF combiner may be approximately 0. Accordingly, comparing the first RSSI and the second RSSI may enable first wireless device 205 to determine the processing gain of the RF combiner. The single element configuration may be achieved by using an on beam (e.g., single element) reception or by using a beam with partial usage of analog receive elements. In some examples, determining the first and second RSSI may be performed when SNR is above a threshold (e.g., the SNR is a mid SNR or a high SNR). For SNR below the threshold, the first wireless device 205 may determine one RSSI (e.g., the second RSSI) in order to have a longer duration for estimating the one RSSI (e.g., both the first portion 220-a and the second portion 220-b of the CP 220 versus just one of the first portion 220-a or the second portion 220-b). In some examples, the SNR may be determined from a previous slot. Additionally or alternatively, SNR may be determined from a modulation and coding scheme (MCS). For instance, if the MCS is above a respective MCS threshold, first wireless device 205 may determine that the SNR is below the SNR threshold. Additionally or alternatively, determining the first and second RSSI may be performed when MCS and/or rank satisfy respective thresholds. Although the first portion 220-a is depicted as occurring before the second portion 220-b, there may be examples in which first portion 220-a occurs after second portion 220-b, in which first portion 220-a overlaps in time but not frequency with second portion 220-b, in which sub-portions of the first portion 220-a and the second portion 220-b alternate, or any combination thereof.

In some examples, calculating the beam gain according to the methods described herein may improve transmitter AGC (e.g., transmitter compensation) and receiver AGC. Additionally, the methods described herein may enable first wireless device 205 to determine that a parameter associated with beam management fails to satisfy a threshold (e.g., a mismatch between the RSSIs or between BG_{actual} and BG_{assumed} is above a respective threshold). In such examples, first wireless device 205 may report (e.g., in the physical (PHY) layer) to higher layers for one or more beam management decisions. As described herein, the first RSSI may be measured on certain time spots (e.g., within a CP) in which less than N analog receive elements are configured to receive signaling. Additionally, the first RSSI may be measured when SNR is not negative, as measuring when the SNR is negative may be associated with a shortage of processing gain which may enable RSSI measurement variance. As described herein, comparing multiple RSSIs to determine the beam gain may improve LNA NF vs. NL tradeoff efficiency.

FIG. 3 illustrates an example of a communication pathway 300 that supports split cyclic prefix beam gain measurement in accordance with aspects of the present disclosure. In some examples, communication pathway 300 may be implemented by one or more aspects of wireless communications systems 100 and/or 200. For instance, communication pathway 300 may be implemented in a UE 115 or a base station 105 as described with reference to FIG. 1, or may be implemented in a first wireless device 205 as described with reference to FIG. 2.

In some examples, communication pathway 300 may include one or more analog receive chains. For instance, communication pathway 300 may include a first analog receive chain 308-a and a second analog receive chain 308-b. Analog receive chain 308-a may include antenna 310-a, LNA 315-a and RF element 320-a. Similarly, analog receive chain 308-b may include antenna 310-b, LNA 315-b, and RF element 320-b. Antennas 310-a and 310-b may receive a beam 305 from a second wireless device (e.g., a UE or a base station). Antenna 310-a may transmit a first corresponding signal to LNA 315-a, which may amplify the first corresponding signal and may pass the amplified first signal to RF element 320-a. Similarly, antenna 310-b may transmit a second corresponding signal to LNA 315-b, which may amplify the second corresponding signal and may pass the amplified second signal to RF element 320-b. RF element 320-a may apply a respective filter to the amplified first signal and RF element 320-b may apply a respective filter to the amplified second signal. RF element 320-a may pass the first amplified signal and RF element 320-b may pass the second amplified signal to RF combiner 325, which may combine the signals. RF combiner 325 may pass the combined signal to analog intermediate frequency (IF) component 330. Analog IF component 330 may shift the combined signal to a different frequency (e.g., an IF) and analog intermediate frequency component 330 may pass the frequency-shifted signal to analog to digital converter (ADC) 335. ADC 335 may digitize the frequency-shifted signal and may pass the digitized signal to digital receiver 340. Digital receiver 340 may demodulate and/or decode the digitized signal based on one or more bits contained in the digitized signal.

In some examples, a wireless device including communication pathway 300 may measure an RSSI at digital receiver 340 at 345. However, if RF combiner 325 received greater than one signal, the processing gain that RF combiner 325 may add to the combined signal may be non-zero. Accordingly, the measured RSSI may be associated with a beam gain that is more different from the actual beam gain of the signal than if the processing gain at RF combiner 325 were zero. Thus, when performing AGC, the wireless device may be more likely to set a gain at LNAs 315-a and/or 315-b that enables a received signal to be too weak for decoding and/or enables the received signal to become over-saturated.

As described herein, the wireless device may measure a first RSSI at digital receiver 340 when a subset of a total set of analog receive elements is configured for receiving. For instance, in the present example, the wireless device may measure a first RSSI at digital receiver 340 when one of analog receive chains 308-a or 308-b is configured for receiving. Accordingly, RF combiner 325 may receive one signal and may not perform combining. Additionally, the wireless device may measure a second RSSI at digital receiver 340 when each of the total set of analog receive elements is configured for receiving. For instance, in the present example, the wireless device may measure a second RSSI at digital receiver 340 when both of analog receive chains 308-a and 308-b are configured for receiving. In such examples, the wireless device may compare the first RSSI and the second RSSI to determine a beam gain that accounts for the processing gain due at least partially to RF combiner 325. In some examples, the methods of the disclosure may be applied to three or more analog receive chains. For instance, the wireless device may measure the first RSSI over a first subset of the three or more analog receive chains (e.g., one or two of the three or more analog receive chains) and may measure the second RSSI over a second subset of the three or more analog receive chains (e.g., two or three analog receive chains of the three or more analog receive chains).

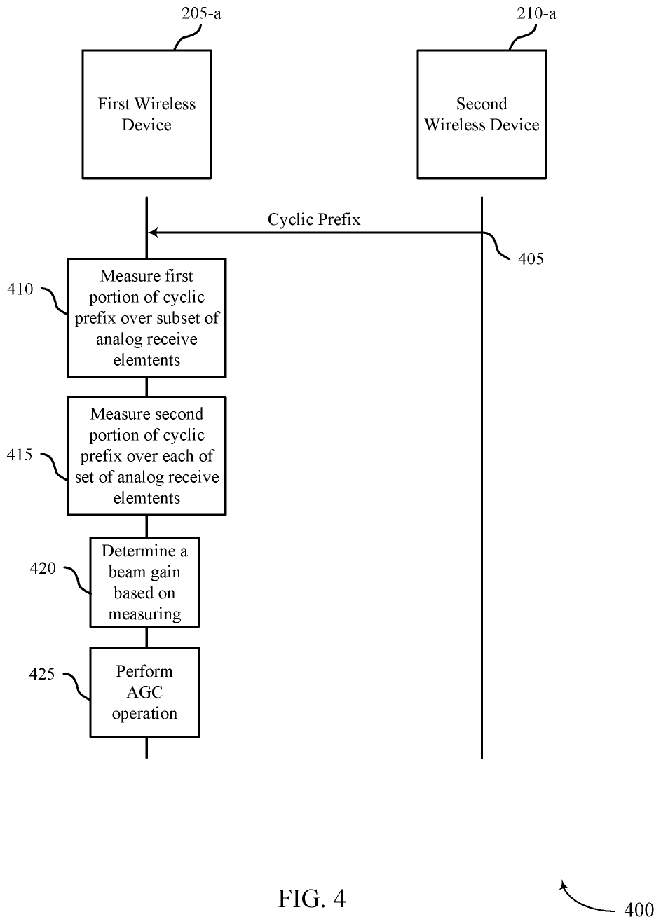

FIG. 4 illustrates an example of a process flow 400 that supports split cyclic prefix beam gain measurement in accordance with aspects of the present disclosure. In some examples, process flow 400 may be implemented by one or more aspects of wireless communications systems 100 and/or 200. For instance, first wireless device 205-a may be an example of a first wireless device 205-a as described with reference to FIG. 2 or a UE 115 or a base station 105 as described with reference to FIG. 1. Additionally, second wireless device 210-a may be an example of a second wireless device 210-a as described with reference to FIG. 2 or a UE 115 or a base station 105 as described with reference to FIG. 1.

At 405, second wireless device 210-a may transmit, to first wireless device 205-a, a cyclic prefix.

At 410, first wireless device 205-a may measure a first portion of a cyclic prefix of a wireless transmissions received using a first subset of a set of analog receive elements (e.g., using one of analog receive chains 308-a or 308-b of FIG. 3, where the other of analog receive chains 308-a or 308-b is turned off or deactivated), where the first subset excludes at least one analog receive element of the set. In some examples, first wireless device 205-a may determine that an SNR parameter is above a threshold value and may measure the first portion of the cyclic prefix received using the first subset of the set of analog receive elements based on determining that the SNR is above the threshold value. In some examples, first wireless device 205-a may determine a first RSSI based on measuring the first portion of the cyclic prefix. In some examples, the first subset of the set of analog receive elements comprises a first subset of analog receive chains of a set of analog receive chains, and wherein the second subset of the set of analog receive elements comprises a second subset of analog receive chains of the set of analog receive chains.

At 415, first wireless device 205-a may measure a second portion of the cyclic prefix of the wireless transmission received using a second subset of the set of analog receive elements (e.g., using both of analog receive chains 308-a and 308-b of FIG. 3), where the second subset includes the at least one analog receive element of the set and one or more analog receive elements of the first subset. In some examples, first wireless device 205-a may determine a second RSSI based on measuring the second portion of the cyclic prefix.

At 420, first wireless device 205-a may determine a beam gain for the set of analog receive elements based on measuring the first portion of the cyclic prefix received using the first subset and the second portion of the cyclic prefix received using the second subset of the set of analog receive elements. In some examples, determining the beam gain for the set of analog receive elements may be based on the determined first RSSI and the second RSSI. In some examples, first wireless device 205-a may compare the first RSSI with the second RSSI, where determining the beam gain is based on comparing the first RSSI with the second RSSI.

At 425, first wireless device 205-a may perform an automatic gain control operation for the set of analog receive elements based on determining the beam gain. In some examples, first wireless device 205-a may communicate a PDSCH transmission, a PDCCH transmission, an SSB, a TRS, or any combination thereof based on the determined beam gain.

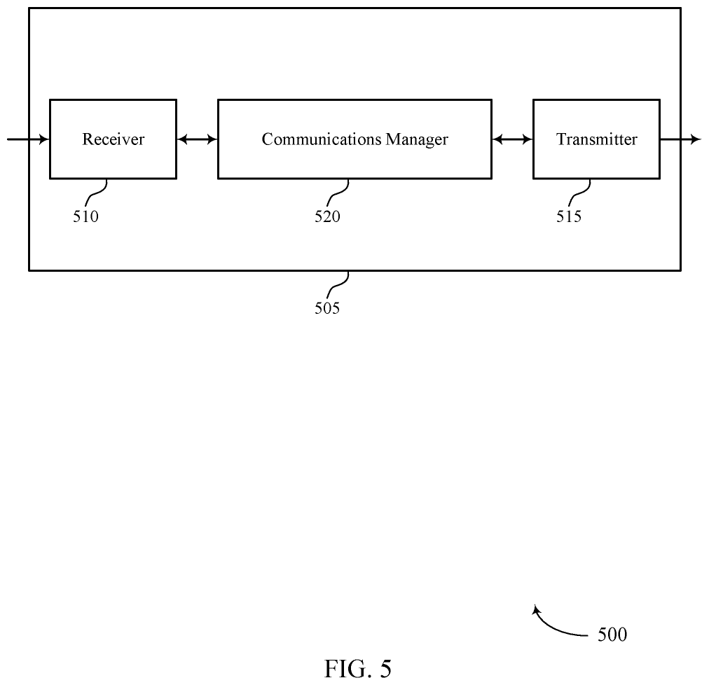

FIG. 5 shows a block diagram 500 of a device 505 that supports split cyclic prefix beam gain measurement in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to split cyclic prefix beam gain measurement). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to split cyclic prefix beam gain measurement). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of split cyclic prefix beam gain measurement as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a wireless device in accordance with examples as disclosed herein. For example, the communications manager 520 may be configured as or otherwise support a means for measuring a first portion of a cyclic prefix of a wireless transmission received using a first subset of a set of analog receive elements, wherein the first subset excludes at least one analog receive element of the set. The communications manager 520 may be configured as or otherwise support a means for measuring a second portion of the cyclic prefix of the wireless transmission received using a second subset of the set of analog receive elements, wherein the second subset includes the at least one analog receive element of the set and one or more analog receive elements of the first subset. The communications manager 520 may be configured as or otherwise support a means for determining a beam gain for the set of analog receive elements based at least in part on measuring the first portion of the cyclic prefix received using the first subset and the second portion of the cyclic prefix received using the second subset of the set of analog receive elements. The communications manager 520 may be configured as or otherwise support a means for performing an automatic gain control operation for the set of analog receive elements based at least in part on determining the beam gain.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for the device 505 to determine a beam gain that is closer to an actual beam gain associated with a signal by accounting for a processing gain as compared to at least some examples in which the device 505 determines the beam gain without accounting for the processing gain.

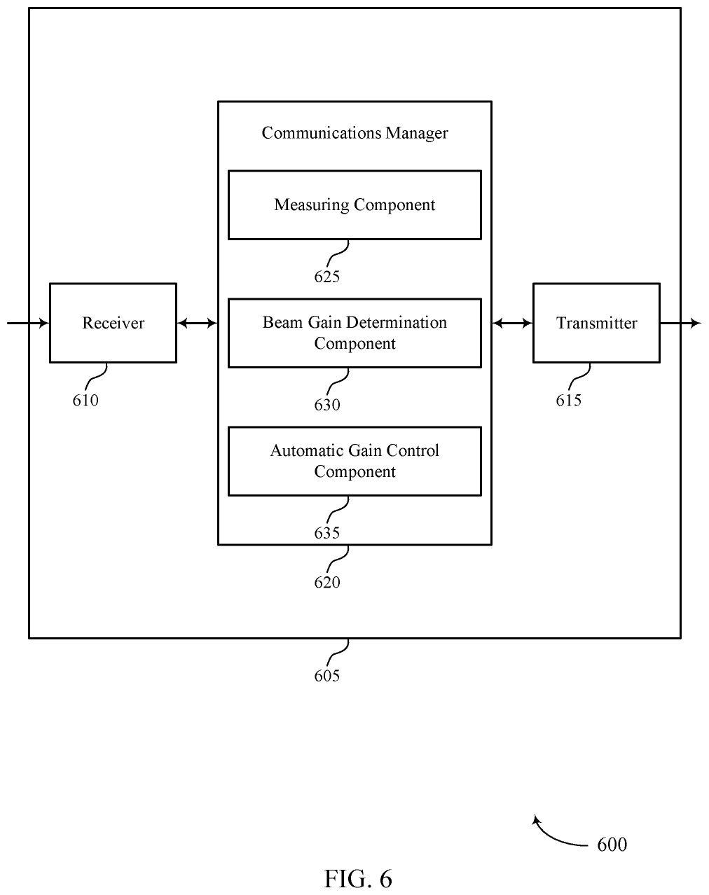

FIG. 6 shows a block diagram 600 of a device 605 that supports split cyclic prefix beam gain measurement in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to split cyclic prefix beam gain measurement). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to split cyclic prefix beam gain measurement). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of split cyclic prefix beam gain measurement as described herein. For example, the communications manager 620 may include a measuring component 625, a beam gain determination component 630, an automatic gain control component 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a wireless device in accordance with examples as disclosed herein. The measuring component 625 may be configured as or otherwise support a means for measuring a first portion of a cyclic prefix of a wireless transmission received using a first subset of a set of analog receive elements, wherein the first subset excludes at least one analog receive element of the set. The measuring component 625 may be configured as or otherwise support a means for measuring a second portion of the cyclic prefix of the wireless transmission received using a second subset of the set of analog receive elements, wherein the second subset includes the at least one analog receive element of the set and one or more analog receive elements of the first subset. The beam gain determination component 630 may be configured as or otherwise support a means for determining a beam gain for the set of analog receive elements based at least in part on measuring the first portion of the cyclic prefix received using the first subset and the second portion of the cyclic prefix received using the second subset of the set of analog receive elements. The automatic gain control component 635 may be configured as or otherwise support a means for performing an automatic gain control operation for the set of analog receive elements based at least in part on determining the beam gain.

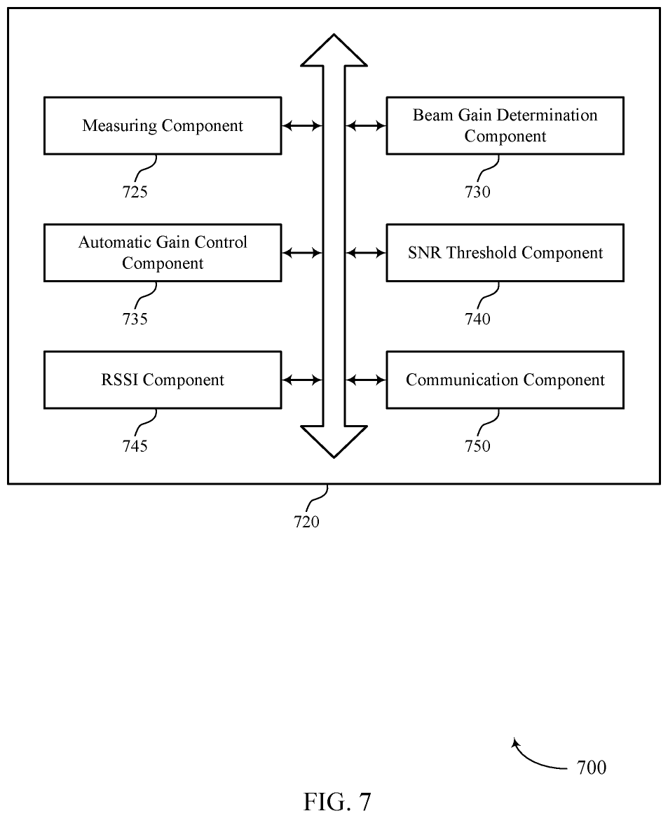

FIG. 7 shows a block diagram 700 of a communications manager 720 that supports split cyclic prefix beam gain measurement in accordance with aspects of the present disclosure. The communications manager 720 may be an example of aspects of a communications manager 520, a communications manager 620, or both, as described herein. The communications manager 720, or various components thereof, may be an example of means for performing various aspects of split cyclic prefix beam gain measurement as described herein. For example, the communications manager 720 may include a measuring component 725, a beam gain determination component 730, an automatic gain control component 735, an SNR threshold component 740, an RSSI component 745, a communication component 750, or any combination thereof. Each of these components may communicate, directly or indirectly, with one another (e.g., via one or more buses).

The communications manager 720 may support wireless communication at a wireless device in accordance with examples as disclosed herein. The measuring component 725 may be configured as or otherwise support a means for measuring a first portion of a cyclic prefix of a wireless transmission received using a first subset of a set of analog receive elements, wherein the first subset excludes at least one analog receive element of the set. In some examples, the measuring component 725 may be configured as or otherwise support a means for measuring a second portion of the cyclic prefix of the wireless transmission received using a second subset of the set of analog receive elements, wherein the second subset includes the at least one analog receive element of the set and one or more analog receive elements of the first subset. The beam gain determination component 730 may be configured as or otherwise support a means for determining a beam gain for the set of analog receive elements based at least in part on measuring the first portion of the cyclic prefix received using the first subset and the second portion of the cyclic prefix received using the second subset of the set of analog receive elements. The automatic gain control component 735 may be configured as or otherwise support a means for performing an automatic gain control operation for the set of analog receive elements based at least in part on determining the beam gain.

In some examples, the SNR threshold component 740 may be configured as or otherwise support a means for determining that a signal to noise ratio parameter is above a threshold value. In some examples, the measuring component 725 may be configured as or otherwise support a means for measuring the first portion of the cyclic prefix received using the first subset of the set of analog receive elements based at least in part on determining that the signal to noise ratio is above the threshold value.

In some examples, the RSSI component 745 may be configured as or otherwise support a means for determining a first received signal strength indicator based at least in part on measuring the first portion of the cyclic prefix. In some examples, the RSSI component 745 may be configured as or otherwise support a means for determining a second received signal strength indicator based at least in part on measuring the second portion of the cyclic prefix, wherein determining the beam gain for the set of analog receive elements is based at least in part on the determined first received signal strength indicator and the second received signal strength indicator.

In some examples, the RSSI component 745 may be configured as or otherwise support a means for comparing the first received signal strength indicator with the second received signal strength indicator, wherein determining the beam gain is based at least in part on comparing the first received signal strength indicator with the second received signal strength indicator.

In some examples, the measuring component 725 may be configured as or otherwise support a means for measuring an additional portion of the wireless transmission distinct from the cyclic prefix, wherein determining the second received signal strength indicator is based at least in part on measuring the additional portion of the wireless transmission.

In some examples, the communication component 750 may be configured as or otherwise support a means for communicating a physical downlink shared channel transmission, a physical downlink control channel transmission, a synchronization signal block, a transmission reference signal, or any combination thereof based at least in part on the determined beam gain.

In some examples, the first subset of the set of analog receive elements comprises a first subset of analog receive chains of a set of analog receive chains, and wherein the second subset of the set of analog receive elements comprises a second subset of analog receive chains of the set of analog receive chains.

In some examples, the wireless device includes a UE or a base station.

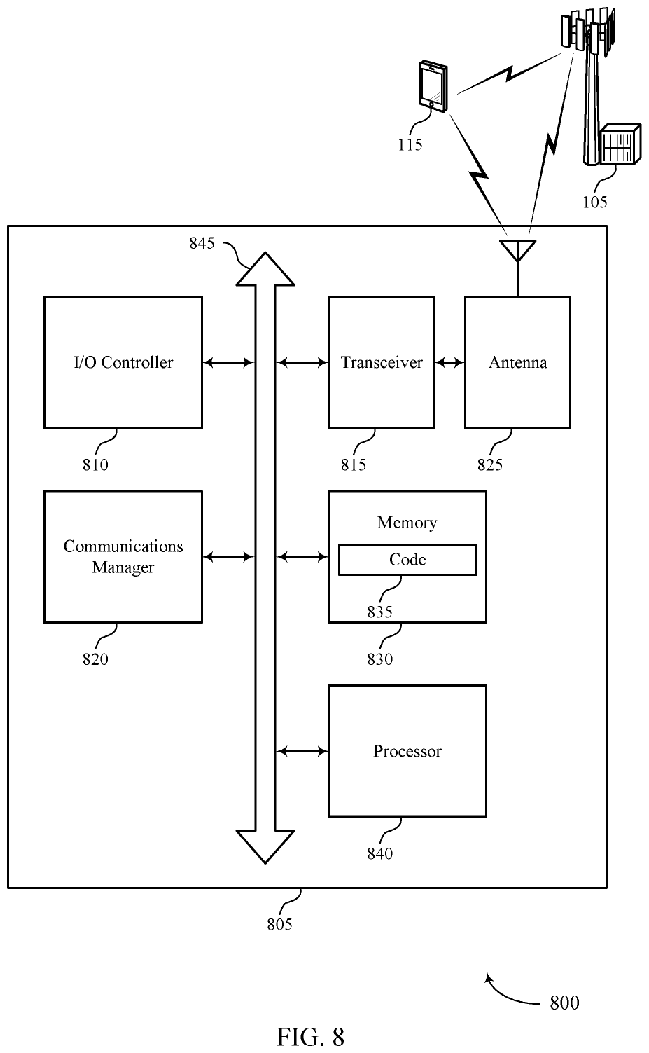

FIG. 8 shows a diagram of a system 800 including a device 805 that supports split cyclic prefix beam gain measurement in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting split cyclic prefix beam gain measurement). For example, the device 805 or a component of the device 805 may include a processor 840 and memory 830 coupled with or to the processor 840, the processor 840 and memory 830 configured to perform various functions described herein.

The communications manager 820 may support wireless communication at a wireless device in accordance with examples as disclosed herein. For example, the communications manager 820 may be configured as or otherwise support a means for measuring a first portion of a cyclic prefix of a wireless transmission received using a first subset of a set of analog receive elements, wherein the first subset excludes at least one analog receive element of the set. The communications manager 820 may be configured as or otherwise support a means for measuring a second portion of the cyclic prefix of the wireless transmission received using a second subset of the set of analog receive elements, wherein the second subset includes the at least one analog receive element of the set and one or more analog receive elements of the first subset. The communications manager 820 may be configured as or otherwise support a means for determining a beam gain for the set of analog receive elements based at least in part on measuring the first portion of the cyclic prefix received using the first subset and the second portion of the cyclic prefix received using the second subset of the set of analog receive elements. The communications manager 820 may be configured as or otherwise support a means for performing an automatic gain control operation for the set of analog receive elements based at least in part on determining the beam gain.

By including or configuring the communications manager 820 in accordance with examples as described herein, the device 805 may support techniques for the device 805 to determine a beam gain that is closer to an actual beam gain associated with a signal by accounting for a processing gain as compared to at least some examples in which the device 805 determines the beam gain without accounting for the processing gain.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of split cyclic prefix beam gain measurement as described herein, or the processor 840 and the memory 830 may be otherwise configured to perform or support such operations.

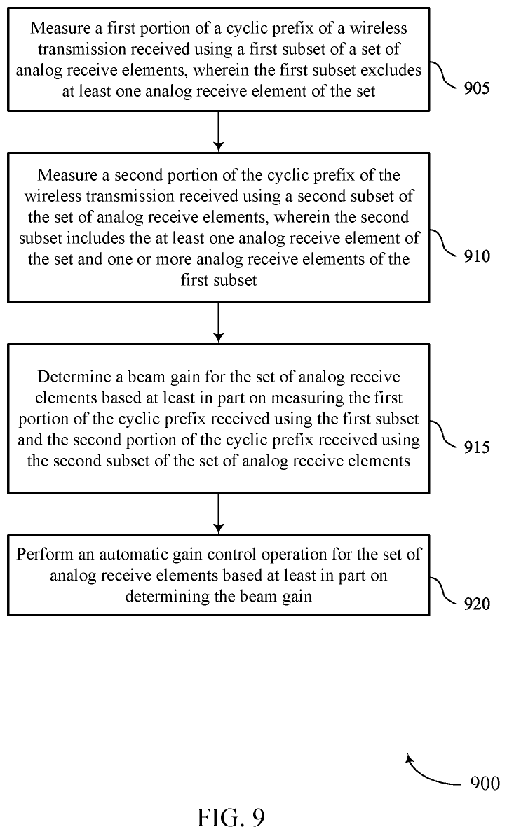

FIG. 9 shows a flowchart illustrating a method 900 that supports split cyclic prefix beam gain measurement in accordance with aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 905, the method may include measuring a first portion of a cyclic prefix of a wireless transmission received using a first subset of a set of analog receive elements, wherein the first subset excludes at least one analog receive element of the set. The operations of 905 may be performed in accordance with examples as disclosed herein. In some examples, aspects of the operations of 905 may be performed by a measuring component 725 as described with reference to FIG. 7.

At 910, the method may include measuring a second portion of the cyclic prefix of the wireless transmission received using a second subset of the set of analog receive elements, wherein the second subset includes the at least one analog receive element of the set and one or more analog receive elements of the first subset. The operations of 910 may be performed in accordance with examples as disclosed herein. In some examples, aspects of the operations of 910 may be performed by a measuring component 725 as described with reference to FIG. 7.

At 915, the method may include determining a beam gain for the set of analog receive elements based at least in part on measuring the first portion of the cyclic prefix received using the first subset and the second portion of the cyclic prefix received using the second subset of the set of analog receive elements. The operations of 915 may be performed in accordance with examples as disclosed herein. In some examples, aspects of the operations of 915 may be performed by a beam gain determination component 730 as described with reference to FIG. 7.

At 920, the method may include performing an automatic gain control operation for the set of analog receive elements based at least in part on determining the beam gain. The operations of 920 may be performed in accordance with examples as disclosed herein. In some examples, aspects of the operations of 920 may be performed by an automatic gain control component 735 as described with reference to FIG. 7.

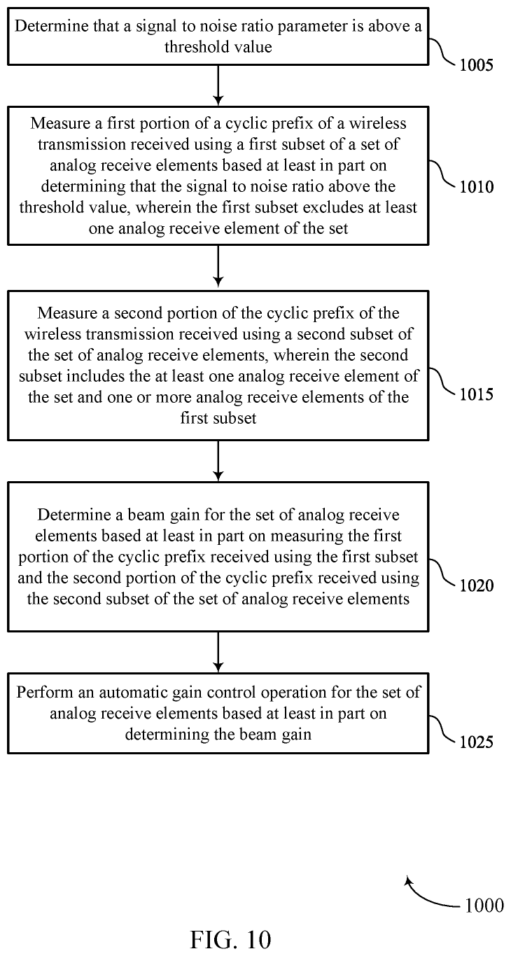

FIG. 10 shows a flowchart illustrating a method 1000 that supports split cyclic prefix beam gain measurement in accordance with aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1005, the method may include determining that a signal to noise ratio parameter is above a threshold value. The operations of 1005 may be performed in accordance with examples as disclosed herein. In some examples, aspects of the operations of 1005 may be performed by an SNR threshold component 740 as described with reference to FIG. 7.

At 1010, the method may include measuring a first portion of a cyclic prefix of a wireless transmission received using a first subset of a set of analog receive elements based at least in part on determining that the signal to noise ratio above the threshold value, wherein the first subset excludes at least one analog receive element of the set. The operations of 1010 may be performed in accordance with examples as disclosed herein. In some examples, aspects of the operations of 1010 may be performed by a measuring component 725 as described with reference to FIG. 7.

At 1015, the method may include measuring a second portion of the cyclic prefix of the wireless transmission received using a second subset of the set of analog receive elements, wherein the second subset includes the at least one analog receive element of the set and one or more analog receive elements of the first subset. The operations of 1015 may be performed in accordance with examples as disclosed herein. In some examples, aspects of the operations of 1015 may be performed by a measuring component 725 as described with reference to FIG. 7.

At 1020, the method may include determining a beam gain for the set of analog receive elements based at least in part on measuring the first portion of the cyclic prefix received using the first subset and the second portion of the cyclic prefix received using the second subset of the set of analog receive elements. The operations of 1020 may be performed in accordance with examples as disclosed herein. In some examples, aspects of the operations of 1020 may be performed by a beam gain determination component 730 as described with reference to FIG. 7.

At 1025, the method may include performing an automatic gain control operation for the set of analog receive elements based at least in part on determining the beam gain. The operations of 1025 may be performed in accordance with examples as disclosed herein. In some examples, aspects of the operations of 1025 may be performed by an automatic gain control component 735 as described with reference to FIG. 7.

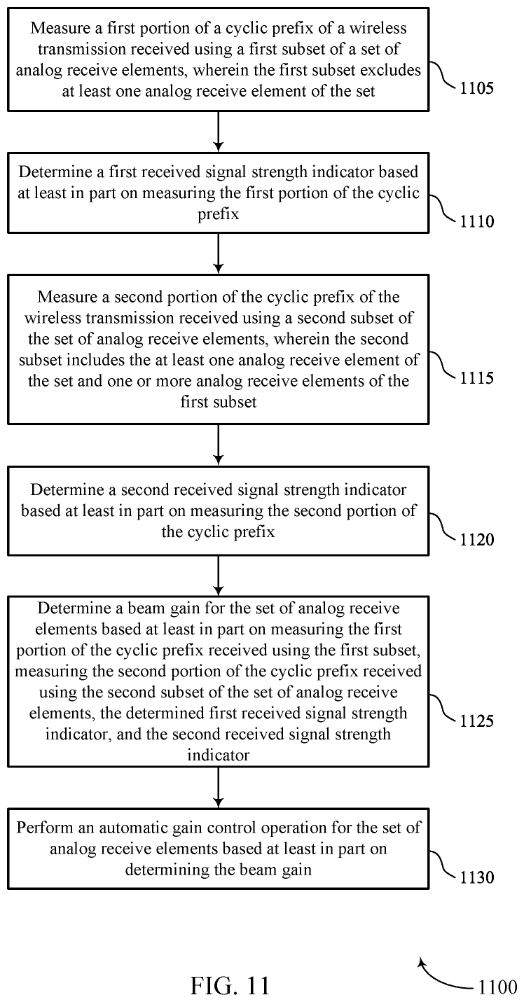

FIG. 11 shows a flowchart illustrating a method 1100 that supports split cyclic prefix beam gain measurement in accordance with aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1105, the method may include measuring a first portion of a cyclic prefix of a wireless transmission received using a first subset of a set of analog receive elements, wherein the first subset excludes at least one analog receive element of the set. The operations of 1105 may be performed in accordance with examples as disclosed herein. In some examples, aspects of the operations of 1105 may be performed by a measuring component 725 as described with reference to FIG. 7.

At 1110, the method may include determining a first received signal strength indicator based at least in part on measuring the first portion of the cyclic prefix. The operations of 1110 may be performed in accordance with examples as disclosed herein. In some examples, aspects of the operations of 1110 may be performed by an RSSI component 745 as described with reference to FIG. 7.

At 1115, the method may include measuring a second portion of the cyclic prefix of the wireless transmission received using a second subset of the set of analog receive elements, wherein the second subset includes the at least one analog receive element of the set and one or more analog receive elements of the first subset. The operations of 1115 may be performed in accordance with examples as disclosed herein. In some examples, aspects of the operations of 1115 may be performed by a measuring component 725 as described with reference to FIG. 7.

At 1120, the method may include determining a second received signal strength indicator based at least in part on measuring the second portion of the cyclic prefix. The operations of 1120 may be performed in accordance with examples as disclosed herein. In some examples, aspects of the operations of 1120 may be performed by an RSSI component 745 as described with reference to FIG. 7.

At 1125, the method may include determining a beam gain for the set of analog receive elements based at least in part on measuring the first portion of the cyclic prefix received using the first subset, measuring the second portion of the cyclic prefix received using the second subset of the set of analog receive elements, the determined first received signal strength indicator, and the second received signal strength indicator. The operations of 1125 may be performed in accordance with examples as disclosed herein. In some examples, aspects of the operations of 1125 may be performed by a beam gain determination component 730 as described with reference to FIG. 7.

At 1130, the method may include performing an automatic gain control operation for the set of analog receive elements based at least in part on determining the beam gain. The operations of 1130 may be performed in accordance with examples as disclosed herein. In some examples, aspects of the operations of 1130 may be performed by an automatic gain control component 735 as described with reference to FIG. 7.

The following provides an overview of aspects of the present disclosure:

Aspect 1: A method for wireless communication at a wireless device, comprising: measuring a first portion of a cyclic prefix of a wireless transmission received using a first subset of a set of analog receive elements, wherein the first subset excludes at least one analog receive element of the set; measuring a second portion of the cyclic prefix of the wireless transmission received using a second subset of the set of analog receive elements, wherein the second subset includes the at least one analog receive element of the set and one or more analog receive elements of the first subset; determining a beam gain for the set of analog receive elements based at least in part on measuring the first portion of the cyclic prefix received using the first subset and the second portion of the cyclic prefix received using the second subset of the set of analog receive elements; and performing an automatic gain control operation for the set of analog receive elements based at least in part on determining the beam gain.

Aspect 2: The method of aspect 1, further comprising: determining that a signal to noise ratio parameter is above a threshold value; and measuring the first portion of the cyclic prefix received using the first subset of the set of analog receive elements based at least in part on determining that the signal to noise ratio is above the threshold value.

Aspect 3: The method of any of aspects 1 through 2, further comprising: determining a first received signal strength indicator based at least in part on measuring the first portion of the cyclic prefix; and determining a second received signal strength indicator based at least in part on measuring the second portion of the cyclic prefix, wherein determining the beam gain for the set of analog receive elements is based at least in part on the determined first received signal strength indicator and the second received signal strength indicator.

Aspect 4: The method of aspect 3, further comprising: comparing the first received signal strength indicator with the second received signal strength indicator, wherein determining the beam gain is based at least in part on comparing the first received signal strength indicator with the second received signal strength indicator.

Aspect 5: The method of any of aspects 3 through 4, further comprising: measuring an additional portion of the wireless transmission distinct from the cyclic prefix, wherein determining the second received signal strength indicator is based at least in part on measuring the additional portion of the wireless transmission.

Aspect 6: The method of any of aspects 1 through 5, further comprising: communicating a physical downlink shared channel transmission, a physical downlink control channel transmission, a synchronization signal block, a transmission reference signal, or any combination thereof based at least in part on the determined beam gain.

Aspect 7: The method of any of aspects 1 through 6, wherein the first subset of the set of analog receive elements comprises a first subset of analog receive chains of a set of analog receive chains, and the second subset of the set of analog receive elements comprises a second subset of analog receive chains of the set of analog receive chains.

Aspect 8: The method of any of aspects 1 through 7, wherein the wireless device comprises a UE or a base station.

Aspect 9: An apparatus for wireless communication at a wireless device, comprising a processor; memory coupled with the processor; and instructions stored in the memory and executable by the processor to cause the apparatus to perform a method of any of aspects 1 through 8.

Aspect 10: An apparatus for wireless communication at a wireless device, comprising at least one means for performing a method of any of aspects 1 through 8.

Aspect 11: A non-transitory computer-readable medium storing code for wireless communication at a wireless device, the code comprising instructions executable by a processor to perform a method of any of aspects 1 through 8.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a wireless device, comprising:
measuring a first portion of a cyclic prefix of a wireless transmission received using a first subset of a set of analog receive elements, wherein the first subset excludes at least one analog receive element of the set;
measuring a second portion of the cyclic prefix of the wireless transmission received using a second subset of the set of analog receive elements, wherein the second subset includes the at least one analog receive element of the set and one or more analog receive elements of the first subset;
determining a beam gain for the set of analog receive elements based at least in part on measuring the first portion of the cyclic prefix received using the first subset and the second portion of the cyclic prefix received using the second subset of the set of analog receive elements; and
performing an automatic gain control operation for the set of analog receive elements based at least in part on determining the beam gain.

2. The method of claim 1, further comprising:
determining that a signal to noise ratio parameter is above a threshold value; and
measuring the first portion of the cyclic prefix received using the first subset of the set of analog receive elements based at least in part on determining that the signal to noise ratio is above the threshold value.

3. The method of claim 1, further comprising:
determining a first received signal strength indicator based at least in part on measuring the first portion of the cyclic prefix; and
determining a second received signal strength indicator based at least in part on measuring the second portion of the cyclic prefix, wherein determining the beam gain for the set of analog receive elements is based at least in part on the determined first received signal strength indicator and the second received signal strength indicator.

4. The method of claim 3, further comprising:
comparing the first received signal strength indicator with the second received signal strength indicator, wherein determining the beam gain is based at least in part on comparing the first received signal strength indicator with the second received signal strength indicator.

5. The method of claim 3, further comprising:
measuring an additional portion of the wireless transmission distinct from the cyclic prefix, wherein determining the second received signal strength indicator is based at least in part on measuring the additional portion of the wireless transmission.

6. The method of claim 1, further comprising:
communicating a physical downlink shared channel transmission, a physical downlink control channel transmission, a synchronization signal block, a transmission reference signal, or any combination thereof based at least in part on the determined beam gain.

7. The method of claim 1, wherein the first subset of the set of analog receive elements comprises a first subset of analog receive chains of a set of analog receive chains, and wherein the second subset of the set of analog receive elements comprises a second subset of analog receive chains of the set of analog receive chains.

8. The method of claim 1, wherein the wireless device comprises a user equipment (UE) or a base station.

9. An apparatus for wireless communication at a wireless device, comprising:
a processor;
a memory coupled with the processor, wherein the memory comprises instructions executable by the processor to cause the apparatus to:
measure a first portion of a cyclic prefix of a wireless transmission received using a first subset of a set of analog receive elements, wherein the first subset excludes at least one analog receive element of the set;
measure a second portion of the cyclic prefix of the wireless transmission received using a second subset of the set of analog receive elements, wherein the second subset includes the at least one analog receive element of the set and one or more analog receive elements of the first subset;
determine a beam gain for the set of analog receive elements based at least in part on measuring the first portion of the cyclic prefix received using the first subset and the second portion of the cyclic prefix received using the second subset of the set of analog receive elements; and
perform an automatic gain control operation for the set of analog receive elements based at least in part on determining the beam gain.

10. The apparatus of claim 9, wherein the instructions are further executable by the processor to cause the apparatus to:
determine that a signal to noise ratio parameter is above a threshold value; and
measure the first portion of the cyclic prefix received using the first subset of the set of analog receive elements based at least in part on determining that the signal to noise ratio is above the threshold value.

11. The apparatus of claim 9, wherein the instructions are further executable by the processor to cause the apparatus to:
determine a first received signal strength indicator based at least in part on measuring the first portion of the cyclic prefix; and
determine a second received signal strength indicator based at least in part on measuring the second portion of the cyclic prefix, wherein determining the beam gain for the set of analog receive elements is based at least in part on the determined first received signal strength indicator and the second received signal strength indicator.

12. The apparatus of claim 11, wherein the instructions are further executable by the processor to cause the apparatus to:
compare the first received signal strength indicator with the second received signal strength indicator, wherein determining the beam gain is based at least in part on comparing the first received signal strength indicator with the second received signal strength indicator.

13. The apparatus of claim 11, wherein the instructions are further executable by the processor to cause the apparatus to:
measure an additional portion of the wireless transmission distinct from the cyclic prefix, wherein determining the second received signal strength indicator is based at least in part on measuring the additional portion of the wireless transmission.

14. The apparatus of claim 9, wherein the instructions are further executable by the processor to cause the apparatus to:
communicate a physical downlink shared channel transmission, a physical downlink control channel transmission, a synchronization signal block, a transmission reference signal, or any combination thereof based at least in part on the determined beam gain.

15. The apparatus of claim 9, wherein the first subset of the set of analog receive elements comprises a first subset of analog receive chains of a set of analog receive chains, and wherein the second subset of the set of analog receive elements comprises a second subset of analog receive chains of the set of analog receive chains.

16. The apparatus of claim 9, wherein the wireless device comprises a user equipment (UE) or a base station.

17. An apparatus for wireless communication at a wireless device, comprising:
means for measuring a first portion of a cyclic prefix of a wireless transmission received using a first subset of a set of analog receive elements, wherein the first subset excludes at least one analog receive element of the set;
means for measuring a second portion of the cyclic prefix of the wireless transmission received using a second subset of the set of analog receive elements, wherein the second subset includes the at least one analog receive element of the set and one or more analog receive elements of the first subset;
means for determining a beam gain for the set of analog receive elements based at least in part on measuring the first portion of the cyclic prefix received using the first subset and the second portion of the cyclic prefix received using the second subset of the set of analog receive elements; and
means for performing an automatic gain control operation for the set of analog receive elements based at least in part on determining the beam gain.

18. The apparatus of claim 17, further comprising:
means for determining that a signal to noise ratio parameter is above a threshold value; and
means for measuring the first portion of the cyclic prefix received using the first subset of the set of analog receive elements based at least in part on determining that the signal to noise ratio is above the threshold value.

19. The apparatus of claim 17, further comprising:
means for determining a first received signal strength indicator based at least in part on measuring the first portion of the cyclic prefix; and
means for determining a second received signal strength indicator based at least in part on measuring the second portion of the cyclic prefix, wherein determining the beam gain for the set of analog receive elements is based at least in part on the determined first received signal strength indicator and the second received signal strength indicator.

20. The apparatus of claim 19, further comprising:
means for comparing the first received signal strength indicator with the second received signal strength indicator, wherein determining the beam gain is based at least in part on comparing the first received signal strength indicator with the second received signal strength indicator.

21. The apparatus of claim 19, further comprising:
means for measuring an additional portion of the wireless transmission distinct from the cyclic prefix, wherein determining the second received signal strength indicator is based at least in part on measuring the additional portion of the wireless transmission.

22. The apparatus of claim 17, further comprising:
means for communicating a physical downlink shared channel transmission, a physical downlink control channel transmission, a synchronization signal block, a transmission reference signal, or any combination thereof based at least in part on the determined beam gain.

23. The apparatus of claim 17, wherein the first subset of the set of analog receive elements comprises a first subset of analog receive chains of a set of analog receive chains, and wherein the second subset of the set of analog receive elements comprises a second subset of analog receive chains of the set of analog receive chains.

24. The apparatus of claim 17, wherein the wireless device comprises a user equipment (UE) or a base station.

25. A non-transitory computer-readable medium storing code for wireless communication at a wireless device, the code comprising instructions executable by a processor to:
measure a first portion of a cyclic prefix of a wireless transmission received using a first subset of a set of analog receive elements, wherein the first subset excludes at least one analog receive element of the set;
measure a second portion of the cyclic prefix of the wireless transmission received using a second subset of the set of analog receive elements, wherein the second subset includes the at least one analog receive element of the set and one or more analog receive elements of the first subset;
determine a beam gain for the set of analog receive elements based at least in part on measuring the first portion of the cyclic prefix received using the first subset and the second portion of the cyclic prefix received using the second subset of the set of analog receive elements; and
perform an automatic gain control operation for the set of analog receive elements based at least in part on determining the beam gain.

26. The non-transitory computer-readable medium of claim 25, wherein the instructions are further executable by the processor to:
determine that a signal to noise ratio parameter is above a threshold value; and
measure the first portion of the cyclic prefix received using the first subset of the set of analog receive elements based at least in part on determining that the signal to noise ratio is above the threshold value.

27. The non-transitory computer-readable medium of claim 25, wherein the instructions are further executable by the processor to:
determine a first received signal strength indicator based at least in part on measuring the first portion of the cyclic prefix; and
determine a second received signal strength indicator based at least in part on measuring the second portion of the cyclic prefix, wherein determining the beam gain for the set of analog receive elements is based at least in part on the determined first received signal strength indicator and the second received signal strength indicator.

28. The non-transitory computer-readable medium of claim 27, wherein the instructions are further executable by the processor to:
compare the first received signal strength indicator with the second received signal strength indicator, wherein determining the beam gain is based at least in part on comparing the first received signal strength indicator with the second received signal strength indicator.

29. The non-transitory computer-readable medium of claim 27, wherein the instructions are further executable by the processor to:
measure an additional portion of the wireless transmission distinct from the cyclic prefix, wherein determining the second received signal strength indicator is based at least in part on measuring the additional portion of the wireless transmission.

30. The non-transitory computer-readable medium of claim 25, wherein the instructions are further executable by the processor to:
communicate a physical downlink shared channel transmission, a physical downlink control channel transmission, a synchronization signal block, a transmission reference signal, or any combination thereof based at least in part on the determined beam gain.
